(19) United States
(12) Patent Application Publication
(10) Pub. No.: US 2023/0062970 A1
(43) Pub. Date: Mar. 2, 2023

(54) TECHNIQUES FOR DESTINATION FILTERING IN FIRST-STAGE SIDELINK CONTROL INFORMATION

(71) Applicant: QUALCOMM Incorporated, San Diego, CA (US)

(72) Inventors: Lik Hang Silas Fong, Bridgewater, NJ (US); Junyi Li, Fairless Hills, PA (US); Piyush Gupta, Bridgewater, NJ (US); Xiaojie Wang, Hillsborough, NJ (US)

(21) Appl. No.: 17/458,226

(22) Filed: Aug. 26, 2021

(51) Int. Cl. H04W 72/12; H04W 72/04

(52) U.S. Cl. CPC H04W 72/1263; H04W 72/0406; H04W 72/0466; H04W 72/121

(57) ABSTRACT

Methods, systems, and devices for wireless communications are described. In some systems, a first user equipment (UE) and a second UE may communicate in accordance with a sidelink resource allocation Mode 1 according to which the UEs may receive scheduling information from a base station. The first UE may receive first-stage sidelink control information (SCI-1) from the second UE based on a destination filter indicator associated with one or more intended receivers of a message scheduled by the SCI-1. The first UE may decode the SCI-1 and determine, based on the destination filter indicator conveyed by the SCI-1, whether the first UE is an intended receiver of the message scheduled by the SCI-1. If the first UE is an intended receiver, the first UE may decode the message. If the first UE is not an intended receiver, the first UE may refrain from decoding the message.

### FIELD OF TECHNOLOGY

The following relates to wireless communications, including techniques for destination filtering in first-stage sidelink control information (SCI-1).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some systems, a UE may communicate directly with one or more other UEs via a sidelink. In such systems, which may be referred to as sidelink communication systems, UEs may select resources for sidelink transmissions in accordance with a sidelink resource allocation Mode 1 or a sidelink resource allocation Mode 2. In the sidelink resource allocation Mode 1, the UEs may receive scheduling information for sidelink transmissions from a base station. In the sidelink resource allocation Mode 2, the UEs may autonomously select resources for sidelink transmissions without receiving scheduling information from the base station.

### SUMMARY

The described techniques relate to improved methods, systems, devices, and apparatuses that support techniques for destination filtering in first-stage sidelink control information (SCI-1). Generally, the techniques described herein provide for a destination filter in SCI-1, such that unintended receivers of a message scheduled by the SCI-1 may avoid decoding a physical sidelink shared channel (PSSCH) over which the message is scheduled. For example, a user equipment (UE) may receive SCI-1 that is based on a first destination filter indicator associated with one or more intended receivers of a message scheduled by the SCI-1. To determine whether the UE is an intended receiver of the message scheduled by the SCI-1, the UE may decode the SCI-1 and compare (either directly or indirectly) the first destination filter indicator associated with one or more intended receivers with a second destination filter indicator associated with the UE. If the first destination filter indicator and the second destination filter indicator are a same destination filter indicator or are otherwise matching, the UE may receive and decode the message scheduled by the SCI-1. Alternatively, if the first destination filter indicator and the second destination filter indicator are different or non-matching, the UE may refrain from decoding the message scheduled by the SCI-1.

A method for wireless communication at a first UE is described. The method may include receiving, from a second UE over a sidelink control channel, SCI-1 that is based on a first destination filter indicator associated with one or more intended receivers of a message scheduled by the SCI-1, the SCI-1 including a first portion of sidelink control information (SCI) associated with scheduling the message, decoding the SCI-1 based on a second destination filter indicator associated with the first UE, and receiving the message scheduled by the SCI-1 based on the first destination filter indicator and the second destination filter indicator.

An apparatus for wireless communication at a first UE is described. The apparatus may include a processor, memory coupled with the processor, and instructions stored in the memory. The instructions may be executable by the processor to cause the apparatus to receive, from a second UE over a sidelink control channel, SCI-1 that is based on a first destination filter indicator associated with one or more intended receivers of a message scheduled by the SCI-1, the SCI-1 including a first portion of SCI associated with scheduling the message, decode the SCI-1 based on a second destination filter indicator associated with the first UE, and receive the message scheduled by the SCI-1 based on the first destination filter indicator and the second destination filter indicator.

Another apparatus for wireless communication at a first UE is described. The apparatus may include means for receiving, from a second UE over a sidelink control channel, SCI-1 that is based on a first destination filter indicator associated with one or more intended receivers of a message scheduled by the SCI-1, the SCI-1 including a first portion of SCI associated with scheduling the message, means for decoding the SCI-1 based on a second destination filter indicator associated with the first UE, and means for receiving the message scheduled by the SCI-1 based on the first destination filter indicator and the second destination filter indicator.

A non-transitory computer-readable medium storing code for wireless communication at a first UE is described. The code may include instructions executable by a processor to receive, from a second UE over a sidelink control channel, SCI-1 that is based on a first destination filter indicator associated with one or more intended receivers of a message scheduled by the SCI-1, the SCI-1 including a first portion of SCI associated with scheduling the message, decode the SCI-1 based on a second destination filter indicator associated with the first UE, and receive the message scheduled by the SCI-1 based on the first destination filter indicator and the second destination filter indicator.

In some examples of the method, apparatuses, and non-transitory computer-readable medium described herein, the first destination filter indicator and the second destination filter indicator may be a same destination filter indicator and the method, apparatuses, and non-transitory computer-readable medium may include further operations, features, means, or instructions for decoding the message scheduled by the SCI-1 based on the first destination filter indicator and the second destination filter indicator being the same destination filter indicator.

In some examples of the method, apparatuses, and non-transitory computer-readable medium described herein, the SCI-1 includes an indication of the first destination filter indicator and the method, apparatuses, and non-transitory computer-readable medium may include further operations, features, means, or instructions for determining that the first destination filter indicator and the second destination filter indicator may be the same destination filter indicator based on decoding the SCI-1, where decoding the message may be based on determining that the first destination filter indicator and the second destination filter indicator may be the same destination filter indicator.

In some examples of the method, apparatuses, and non-transitory computer-readable medium described herein, the SCI-1 includes one or more cyclic redundancy check (CRC) bits that may be scrambled by a first identifier (ID) associated with the first destination filter indicator and the method, apparatuses, and non-transitory computer-readable medium may include further operations, features, means, or instructions for performing an error check for the SCI-1 using a second ID associated with the second destination filter indicator and passing the error check based on the first ID and the second ID being a same ID, where decoding the message may be based on passing the error check.

In some examples of the method, apparatuses, and non-transitory computer-readable medium described herein, the first destination filter indicator and the second destination filter indicator may be different destination filter indicators and the method, apparatuses, and non-transitory computer-readable medium may include further operations, features, means, or instructions for refraining from decoding the message scheduled by the SCI-1 based on the first destination filter indicator and the second destination filter indicator being different destination filter indicators.

In some examples of the method, apparatuses, and non-transitory computer-readable medium described herein, the SCI-1 includes the first destination filter indicator and the method, apparatuses, and non-transitory computer-readable medium may include further operations, features, means, or instructions for determining that the first destination filter indicator may be different from the second destination filter indicator based on decoding the SCI-1, where refraining from decoding the message may be based on determining that the first destination filter indicator may be different from the second destination filter indicator.

In some examples of the method, apparatuses, and non-transitory computer-readable medium described herein, the SCI-1 includes one or more CRC bits that may be scrambled by a first ID associated with the first destination filter indicator and the method, apparatuses, and non-transitory computer-readable medium may include further operations, features, means, or instructions for performing an error check for the SCI-1 using a second ID associated with the second destination filter indicator and failing the error check based on the first ID being different from the second ID, where refraining from decoding the message may be based on failing the error check.

Some examples of the method, apparatuses, and non-transitory computer-readable medium described herein may further include operations, features, means, or instructions for receiving second-stage SCI (SCI-2) associated with the message, the SCI-2 including a subset of a destination ID or a hash function of the destination ID.

In some examples of the method, apparatuses, and non-transitory computer-readable medium described herein, the subset of the destination ID or the hash function of the destination ID uniquely identifies the one or more intended receivers in combination with the first destination filter indicator associated with the SCI-1.

In some examples of the method, apparatuses, and non-transitory computer-readable medium described herein, the SCI-1 includes an indication of the first destination filter indicator and the method, apparatuses, and non-transitory computer-readable medium may include further operations, features, means, or instructions for receiving SCI-2 including a time and frequency resource assignment for the message based on the SCI-1 including the first destination filter indicator.

In some examples of the method, apparatuses, and non-transitory computer-readable medium described herein, receiving the SCI-1 that may be based on the first destination filter indicator may include operations, features, means, or instructions for receiving an indication of the first destination filter indicator via a quantity of bits in the SCI-1.

In some examples of the method, apparatuses, and non-transitory computer-readable medium described herein, the quantity of bits include a subset of a destination ID associated with the one or more intended receivers or a hash function of the destination ID associated with the one or more intended receivers.

In some examples of the method, apparatuses, and non-transitory computer-readable medium described herein, the quantity of bits include a subset of a source ID associated with the second UE or a hash function of the source ID associated with the second UE.

In some examples of the method, apparatuses, and non-transitory computer-readable medium described herein, the quantity of bits include a complete destination ID associated with the one or more intended receivers or a complete source ID associated with the second UE.

In some examples of the method, apparatuses, and non-transitory computer-readable medium described herein, the second UE and the first UE communicate in accordance with a sidelink resource allocation Mode 1.

A method for wireless communication at a second UE is described. The method may include receiving scheduling information for a message to be transmitted to at least a first UE, transmitting, over a sidelink control channel, SCI-1 that is based on a destination filter indicator associated with one or more intended receivers of the message including at least the first UE, the SCI-1 including a first portion of SCI associated with scheduling the message, and transmitting the message according to the received scheduling information, the transmitting of the message based on the SCI-1.

An apparatus for wireless communication at a second UE is described. The apparatus may include a processor, memory coupled with the processor, and instructions stored in the memory. The instructions may be executable by the processor to cause the apparatus to receive scheduling information for a message to be transmitted to at least a first UE, transmit, over a sidelink control channel, SCI-1 that is based on a destination filter indicator associated with one or more intended receivers of the message including at least the first UE, the SCI-1 including a first portion of SCI associated with scheduling the message, and transmit the message according to the received scheduling information, the transmitting of the message based on the SCI-1.

Another apparatus for wireless communication at a second UE is described. The apparatus may include means for receiving scheduling information for a message to be transmitted to at least a first UE, means for transmitting, over a sidelink control channel, SCI-1 that is based on a destination filter indicator associated with one or more intended receivers of the message including at least the first UE, the SCI-1 including a first portion of SCI associated with scheduling the message, and means for transmitting the message according to the received scheduling information, the transmitting of the message based on the SCI-1.

A non-transitory computer-readable medium storing code for wireless communication at a second UE is described. The code may include instructions executable by a processor to receive scheduling information for a message to be transmitted to at least a first UE, transmit, over a sidelink control channel, SCI-1 that is based on a destination filter indicator associated with one or more intended receivers of the message including at least the first UE, the SCI-1 including a first portion of SCI associated with scheduling the message, and transmit the message according to the received scheduling information, the transmitting of the message based on the SCI-1.

Some examples of the method, apparatuses, and non-transitory computer-readable medium described herein may further include operations, features, means, or instructions for transmitting SCI-2 associated with the message, the SCI-2 including a subset of a destination ID associated with at least the first UE or a hash function of the destination ID associated with at least the first UE.

In some examples of the method, apparatuses, and non-transitory computer-readable medium described herein, the subset of the destination ID associated with at least the first UE or the hash function of the destination ID associated with at least the first UE uniquely identifies at least the first UE in combination with the destination filter indicator associated with the SCI-1.

In some examples of the method, apparatuses, and non-transitory computer-readable medium described herein, the SCI-1 includes an indication of the destination filter indicator and the method, apparatuses, and non-transitory computer-readable medium may include further operations, features, means, or instructions for transmitting SCI-2 including a time and frequency resource assignment for the message based on the SCI-1 including the destination filter indicator.

In some examples of the method, apparatuses, and non-transitory computer-readable medium described herein, transmitting the SCI-1 that may be based on the destination filter indicator associated with at least the first UE may include operations, features, means, or instructions for transmitting the destination filter indicator via a quantity of bits in the SCI-1.

In some examples of the method, apparatuses, and non-transitory computer-readable medium described herein, the quantity of bits include a subset of a destination ID associated with the first UE or a hash function of the destination ID associated with the first UE.

In some examples of the method, apparatuses, and non-transitory computer-readable medium described herein, the quantity of bits include a subset of a source ID associated with the second UE or a hash function of the source ID associated with the second UE.

In some examples of the method, apparatuses, and non-transitory computer-readable medium described herein, the quantity of bits include a complete destination ID associated with the first UE or a complete source ID associated with the second UE.

In some examples of the method, apparatuses, and non-transitory computer-readable medium described herein, transmitting the SCI-1 that may be based on the destination filter indicator associated with the first UE may include operations, features, means, or instructions for transmitting one or more CRC bits that may be scrambled by an ID associated with the destination filter indicator.

In some examples of the method, apparatuses, and non-transitory computer-readable medium described herein, the ID may be shared by a group of UEs including at least the first UE or may be a function of a destination ID associated with at least the first UE.

In some examples of the method, apparatuses, and non-transitory computer-readable medium described herein, receiving the scheduling information for the message to be transmitted to at least the first UE may include operations, features, means, or instructions for receiving the scheduling information from a base station, where the second UE and at least the first UE communicate in accordance with a sidelink resource allocation Mode 1.

### BRIEF DESCRIPTION OF THE DRAWINGS

FIGS. 1 and 2 illustrate examples of wireless communications systems that support techniques for destination filtering in first-stage sidelink control information (SCI-1) in accordance with aspects of the present disclosure.

FIG. 3 illustrates an example of a resource reservation scheme that supports techniques for destination filtering in SCI-1 in accordance with aspects of the present disclosure.

FIG. 4 illustrates an example of a process flow that supports techniques for destination filtering in SCI-1 in accordance with aspects of the present disclosure.

FIGS. 5 and 6 show block diagrams of devices that support techniques for destination filtering in SCI-1 in accordance with aspects of the present disclosure.

FIG. 7 shows a block diagram of a communications manager that supports techniques for destination filtering in SCI-1 in accordance with aspects of the present disclosure.

FIG. 8 shows a diagram of a system including a device that supports techniques for destination filtering in SCI-1 in accordance with aspects of the present disclosure.

FIGS. 9 through 12 show flowcharts illustrating methods that support techniques for destination filtering in SCI-1 in accordance with aspects of the present disclosure.

### DETAILED DESCRIPTION

In some wireless communications systems, multiple user equipment (UEs) may communicate with each other via one or more sidelinks. The multiple UEs may communicate in accordance with various sidelink resource allocation modes, including a sidelink resource allocation Mode 1 according to which the multiple UEs may receive scheduling information from a base station and a sidelink resource allocation Mode 2 according to which the multiple UEs may autonomously make scheduling decisions (e.g., without signaling from the base station). In examples in which the multiple UEs communicate in accordance with the sidelink resource allocation Mode 1, the base station may schedule communication between UEs in a manner that avoids collisions between different sidelink transmissions. In examples in which the multiple UEs communicate in accordance with the sidelink resource allocation Mode 2, the multiple UEs may each perform channel sensing prior to selecting a resource for a sidelink transmission to avoid collisions between different sidelink transmissions.

In Mode 2 operation, each of the multiple UEs may perform the channel sensing using first-stage sidelink control information (SCI-1) transmissions and one or more physical sidelink shared channel (PSSCH) transmissions. Further, in both Mode 1 and Mode 2 operation, each of the multiple UEs may decode a PSSCH transmission scheduled by the SCI-1 to decode second-stage sidelink control information (SCI-2), which may indicate whether a data message carried by the PSSCH and scheduled by the SCI-1 is intended for that UE. As such, a decoding effort for PSSCH transmissions that are not intended for that UE may be wasted and, for at least Mode 1 operation, unnecessary as the UE may also refrain from using the PSSCH for channel sensing.

In some implementations of the present disclosure, a transmitting UE may transmit SCI-1 based on a destination filter indicator, which may enable a receiving UE that receives and decodes the SCI-1 to determine whether a data message scheduled by the SCI-1 is intended for the receiving UE. For example, the receiving UE may refrain from decoding a PSSCH resource associated with (e.g., scheduled or indicated by) the SCI-1 if the receiving UE determines that the receiving UE is not an intended receiver via the destination filter indicator indicated by the SCI-1. Alternatively, the receiving UE may decode the PSSCH resource associated with the SCI-1 if the receiving UE determines that the receiving UE is an intended receiver via the destination filter indicator indicated by the SCI-1. As such, the receiving UE may filter out a subset of PSSCH messages that are not intended for itself and may refrain from decoding any PSSCH messages that the receiving UE filters out.

In some examples, the transmitting UE may include an indication of the destination filter indicator in the SCI-1 via a quantity of bits. In such examples, the receiving UE may compare the destination filter indicator included in the SCI-1 to a second destination filter indicator associated with the receiving UE to determine whether the two destination filter indicators are the same or different and, likewise, whether a corresponding PSSCH message is intended for the receiving UE. In some other examples, the transmitting UE may scramble a set of cyclic redundancy check (CRC) bits of the SCI-1 based on the destination filter indicator and the receiving UE may perform an error check for the SCI-1 using a second destination filter indicator associated with the receiving UE. In such examples, the receiving UE may determine whether the two destination filter indicators are the same or different and, likewise, whether a corresponding PSSCH message is intended for the receiving UE based on whether the receiving passes or fails the error check for the SCI-1.

Particular implementations of the subject matter described in this disclosure can be implemented to realize one or more of the following potential advantages. For example, based on filtering out a subset of PSSCH messages that are not intended for itself, the receiving UE may avoid decoding such filtered out PSSCH messages, which may reduce processing time and power costs based on reducing decoding overhead. Such reduced decoding overhead may, in turn, provide greater power savings to the receiving UE, which may result in longer battery life, increased efficiency associated with processing, or more power being available for other processing tasks. The reduction in decoding overhead may be significant if each filter indicates a relatively small number of destinations (e.g., where a case of relatively largest reduction in decoding overhead may occur if each filter indicates a single destination). Further, the transmitting UE and the receiving UE may experience an increase in communication reliability in examples in which the receiving UE is an intended receiver, as the receiving UE may have access to a greater amount of information that identifies the receiving UE as the intended receiver via the destination filter indicator in SCI-1. Moreover, as a result of transmitting the SCI-1 based on the destination filter indicator, the transmitting UE may re-format or re-configure other content of the SCI-1 or SCI-2, or both, to avoid increasing overall signaling overhead associated with sidelink control information (SCI) transmissions.

Aspects of the disclosure are initially described in the context of wireless communications systems. Aspects of the disclosure are additionally illustrated by and described with reference to a resource reservation scheme and a process flow. Aspects of the disclosure are further illustrated by and described with reference to apparatus diagrams, system diagrams, and flowcharts that relate to techniques for destination filtering in SCI-1.

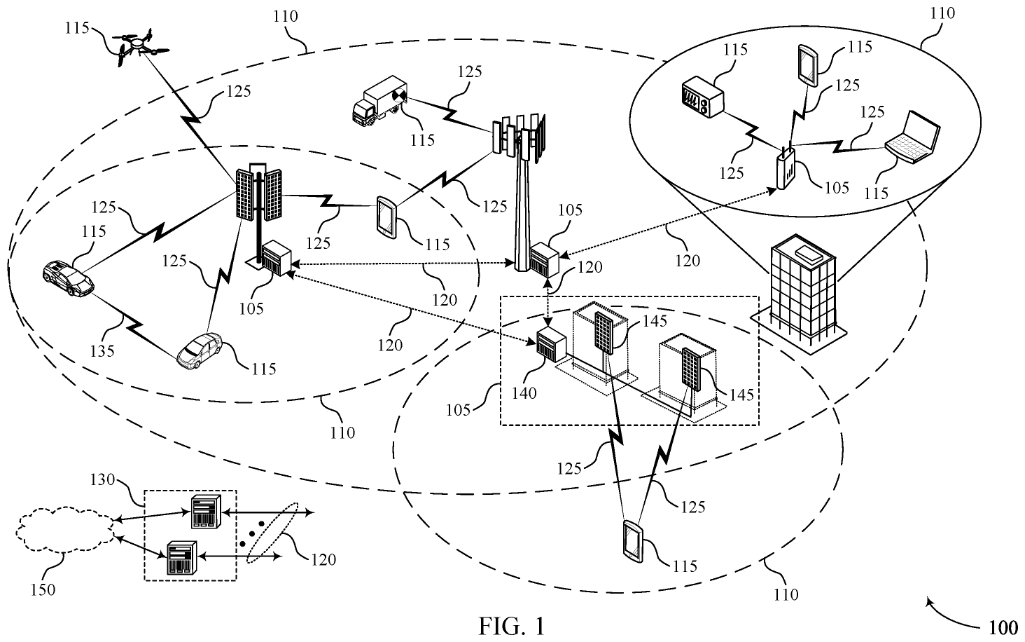

FIG. 1 illustrates an example of a wireless communications system 100 that supports techniques for destination filtering in SCI-1 in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δ, fₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, sometimes in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels. In some cases, UEs 115 may support one or more physical layer procedures for PC5 connections (e.g., sidelink connections).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some systems, such as the wireless communications system 100, two or more UEs 115 may communicate with each other via one or more sidelinks. The UEs 115 may communicate with each other over physical sidelink control channel (PSCCH) resources, PSSCH resources, physical sidelink feedback channel (PSFCH) resources, or any combination thereof, and may communicate in accordance with a sidelink resource allocation Mode 1 or a sidelink resource allocation Mode 2. In examples in which the UEs 115 communicate in accordance with the sidelink resource allocation Mode 1, a UE 115 may receive scheduling information for a sidelink transmission from a base station 105. In some aspects, the UE 115 may receive the scheduling information via downlink control information (DCI), such as DCI format 3_0.

For example, the base station 105 may transmit DCI format 3_0 to the UE 115 for scheduling of one or more PSCCH resources and one or more PSSCH resources (e.g., NR PSSCH and PSSCH in one cell). The base station 105 may scramble a CRC of the DCI format 3_0 by a sidelink radio network temporary identifier (RNTI) parameter, which may include or refer to an SL-RNTI parameter or an SL-CS-RNTI parameter. The DCI format 3_0 may include a resource pool index, a time gap, the HARQ process identifier (ID), a new data indicator (NDI), a lowest index of a sub-channel allocation to an initial transmission, SCI-1 format fields (e.g., one or both of a frequency resource assignment field or a time resource assignment field), a PFSCH-to-HARQ feedback timing indicator, a physical uplink control channel (PUCCH) resource indicator, a configuration index (which may exist for configured grant (CG) scenarios), a counter sidelink assignment index, or any combination thereof.

A transmitting UE 115 may transmit SCI-1, such as SCI 1-A, over a PSCCH resource. In some examples, SCI 1-A may include three priority bits, a frequency resource assignment field (e.g., including a number of bits depending on a number of reserved slots and sub-channels), a time resource assignment field (e.g., including 5 or 9 bits for 2 or 3 reservations, such as 5 bits for 2 reservations and 9 bits for 3 reservations), a resource reservation period field (e.g., including a number of bits depending on a number of allowed periods), a demodulation reference signal (DM-RS) pattern field (e.g., including a number of bits depending on a number of configured patterns), an SCI-2 format field (e.g., including 2 bits), a beta offset for SCI-2 rate matching field (e.g., including 2 bits), a DM-RS port field (e.g., including 1 bit indicating one or two data layers), a modulation and coding scheme (MCS) field (e.g., including 5 bits), an additional MCS table field (e.g., including 0, 1, or 2 bits), a PSFCH overhead indicator field (e.g., including 0 bits or 1 bit), a quantity of reserved bits (e.g., including an upper layer-configured number of bits), or any combination thereof. In some aspects, intended receivers and other sidelink UEs 115 (e.g., especially in Mode 2 operation) may decode SCI 1-A for channel sensing and to avoid resource collision.

The transmitting UE 115 may also transmit SCI-2 over a PSSCH resource. As such, the transmitting UE 115 may transmit both the SCI-2 and a data message over the PSSCH resource. The SCI-2 may be front-loaded and may include a HARQ ID field (e.g., including a number of bits depending on a number of HARQ processes), an NDI field (e.g., including 1 bit), a redundancy version (RV) ID field (e.g., including 2 bits), a source ID field (e.g., including 8 bits), a destination ID field (e.g., including 16 bits), and a HARQ enable or disable indicator field (e.g., including 1 bit). In some examples, such as in examples in which the UE 115 transmits SCI 2-A, the SCI-2 (e.g., the SCI 2-A) may include a cast type field (e.g., including 2 bits) indicating between broadcast, groupcast, and unicast and a channel state information (CSI) request field (e.g., including 1 bit). In some examples, such as in examples in which the UE 115 transmits SCI 2-B, the SCI-2 (e.g., the SCI 2-B) may include a zone ID field (e.g., including 12 bits) and a communication range field (e.g., including 4 bits). In some aspects, intended receivers may decode the SCI-2 to decode a data message (e.g., a data message also sent over the PSSCH resource). In other words, for example, SCI-2 may be intended for receiving UEs to decode PSSCH.

In some implementations, the transmitting UE 115 may transmit SCI-1 based on a destination filter indicator associated with one or more intended receivers of a message scheduled by the SCI-1. In some examples, the transmitting UE 115 may transmit the SCI-1 including an explicit indication of the destination filter indicator. For example, the SCI-1 may include a quantity of bits that convey the destination filter indicator. Additionally or alternatively, the transmitting UE 115 may transmit the SCI-1 including an implicit indication of the destination filter indicator. For example, the SCI-1 may include a quantity of CRC bits and the transmitting UE 115 may scramble the quantity of CRC bits based on the destination filter indicator. A receiving UE 115 may decode the SCI-1 and compare the destination filter indicator conveyed by the quantity of bits with a destination filter indicator of the receiving UE 115 or may perform an error check for the SCI-1 using the destination filter indicator of the receiving UE 115 and may determine whether to decode the message scheduled by the SCI-1 depending on whether the destination filter indicator associated with the intended receivers is the same as the destination filter indicator of the receiving UE 115.

Further, first-stage SCI (which may be defined herein as SCI-1) may include a first portion of SCI associated with scheduling a PSSCH message and second-stage SCI (which may be defined herein as SCI-2) may include a second portion of the SCI associated with scheduling the PSSCH message. As such, first-stage SCI (e.g., SCI-1) and second-stage SCI (e.g., SCI-2) together may include the information that a receiving UE 115 may use to receive and decode the PSSCH message. Further, first-stage may refer to a portion that a transmitting UE 115 transmits first or initially and second-stage may refer to a portion that the transmitting UE 115 transmits second or lastly (e.g., after transmitting the first-stage). Additionally or alternatively, first-stage may refer to a portion that a receiving UE 115 decodes first or initially and second-stage may refer to a portion that the receiving UE 115 decodes second or lastly (e.g., after decoding the first-stage). Additionally or alternatively, first-stage may refer to a portion that is sent over a PSCCH and second-stage may refer to a portion that is sent over a PSSCH.

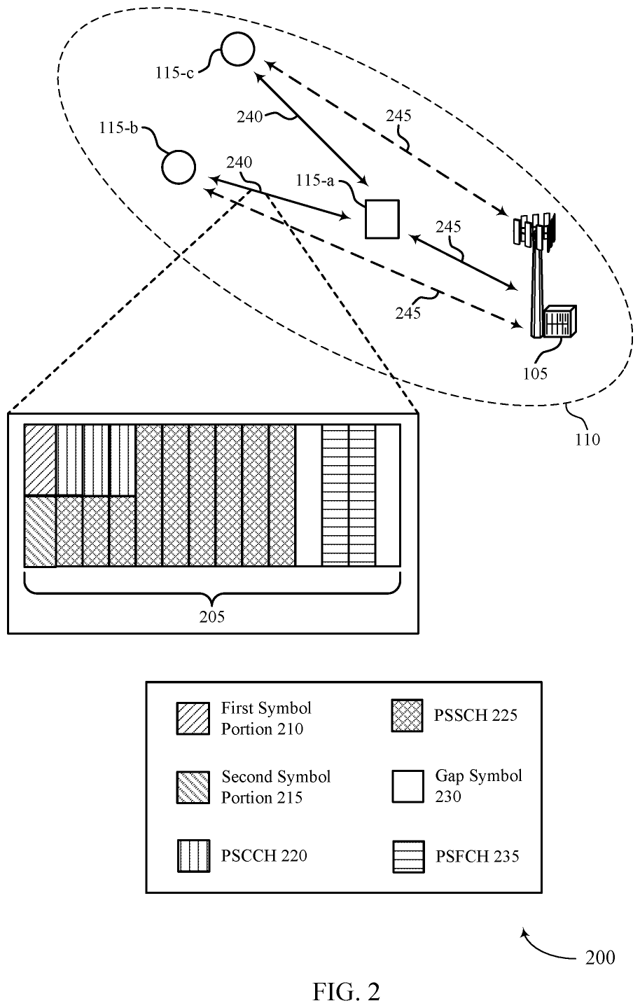

FIG. 2 illustrates an example of a wireless communications system 200 that supports techniques for destination filtering in SCI-1 in accordance with aspects of the present disclosure. In some examples, the wireless communications system 200 may implement or be implemented to realize aspects of the wireless communications system 100. For example, the wireless communications system 100 may illustrate communication between a UE 115-a, a UE 115-b, a UE 115-c, and a base station 105, which may be examples of UEs 115 and base stations 105 as described with reference to FIG. 1. In some examples, the UE 115-a, the UE 115-b, and the UE 115-c may communicate with each other within a sidelink network and may support a SCI formatting to convey a destination filter indicator associated with one or more intended receivers via SCI-1.

For example, the UEs 115 may communicate with each other via one or more sidelinks 240 and may communicate in accordance with a slot format 205 associated with sidelink communication. In some aspects, the slot format 205 may include a first symbol portion 210, a second symbol portion 215, a PSCCH 220 (e.g., including SCI-1), a PSSCH 225 (e.g., including SCI-2 and data), one or more gap symbols 230, and a PSFCH 235. In some aspects, and as illustrated in FIG. 2, the UE 115-a may communicate with one or both of the UE 115-b and the UE 115-c via sidelinks 240 and one or more of the UE 115-a, the UE 115-b, and the UE 115-c may communicate with the base station 105 via communication links 245 within a geographic coverage area 110 of the base station 105.

In some deployment scenarios, the UEs 115 may communicate with each other within a factory automation deployment or an industrial IoT (I-IoT) scenario and may perform autonomous functions (e.g., tasks or actions related to factory automation) based on their communication. In such deployment scenarios, the UE 115-a may be an example of or otherwise function as a programmable logic controller (PLC) and the UE 115-b and the UE 115-c may be examples of or otherwise function as sensors or actuators (S/As). In some examples, traffic between a PLC and a number of S/As may be cyclic in nature and such cyclic exchanges may be associated with deterministic and periodic traffic. For example, mission-critical traffic may be deterministic or periodic due to the cyclic exchanges between the PLC and the number of S/As. Such a cyclic exchange may include a receiving of a message (e.g., a downlink telegram) from a PLC at an S/A after some propagation delay T_{D-DL} and transmitting a responsive message (e.g., an uplink telegram) from the S/A to the PLC after some processing delay T_{AP} (e.g., and expecting the PLC to transmit another message some processing delay T_{AP} after receiving the uplink telegram, which may be associated with some propagation delay T_{D-UL}) within a cyclic time T_{cyc}. In other words, T_{cyc}=T_{D-DL}+T_{AP}+T_{D-UL}+T_{AP}.

In some cases, for example, if performing autonomous functions (e.g., functions related to factory automation), the UE 115-a, which may be an example of or otherwise function as a PLC, may request information from associated (e.g., linked) S/As (e.g., such as one or both of the UE 115-b or the UE 115-c) in order to gain information pertinent to system functionality. For example, a PLC may communicate with a number of S/As to receive information associated with one or more component parameters (e.g., temperature, location, etc.). This traffic may be mission-critical (e.g., deterministic or periodic) and the UEs 115 may operate or communicate according to strict or stringent latency and reliability constraints (e.g., with latency approximately around 1 to 2 milliseconds and reliability on the order of 10⁻⁶). Both data and control channels may be designed to meet these overall reliability constraints. Further, in some cases, the UEs 115 may minimize or otherwise reduce overhead due to various headers such that, for example, the UEs 115 may communicate small application-layer payloads (e.g., including payloads of approximately 40 to 256 bytes).

Further, in such factory automation deployment scenarios, there may be a relatively large number of S/As per PLC (e.g., such as approximately 20 to 50 S/As per PLC) and there may be a relatively large number of PLCs in a facility (e.g., such as approximately 100 to 1000 PLCs). As such, making PLC connectivity wireless may significantly reduce a re-configuration cost. For example, if a manufacturer re-configures a layout or an operational structure of a factory floor, wireless PLC to S/A connectivity may save time and cost (as re-wiring may be avoided). In such examples of wireless PLC connectivity, each wireless PLC (e.g., such as the UE 115-a) may communicate with the base station 105 through a Uu interface (e.g., a communication link 245) and may communicate with one or more S/As (e.g., such as the UE 115-b and the UE 115-c) through one or more PC5 interfaces (e.g., via sidelinks 240). In some deployments, PLCs may be located close to machinery and the base station 105 may be located elsewhere, such as being ceiling-mounted.

In some scenarios, such as in scenarios in which line-of-sight (LoS) links between the one or more S/As and the base station 105 are inconsistent or sporadic, the one or more S/As (e.g., such as the UE 115-b and the UE 115-c) may lack a reliable communication link 245 to the base station 105 and may rely on the PLC (e.g., the UE 115-a) for scheduling information. In some other scenarios, the communication links 245 between the one or more S/As (e.g., such as the UE 115-b and the UE 115-c) and the base station 105 may be associated with suitable channel quality and, as such, the S/As may communicate directly with the base station 105 and may receive scheduling information from the base station 105 (e.g., in Mode 1 operation).

Further, although initially described in the context of a factory automation deployment, the wireless communications system 200 may illustrate any sidelink deployment scenario. For example, the wireless communications system 200 may additionally or alternatively be understood as a V2X deployment and the UEs 115 may communicate with each other in accordance with a V2X Mode 1 (e.g., which may be an example of a sidelink resource allocation Mode 1) or a V2X Mode 2 (e.g., which may be an example of a sidelink resource allocation Mode 2). In examples in which the UEs 115 communicate in accordance with the V2X Mode 1, the base station 105 may schedule one or more sidelink resources for use by a UE 115 for one or more sidelink transmissions through either or both of RRC signaling or DCI format 3_0. Thus, not every UE 115 may perform channel sensing to avoid a resource collision (e.g., as the base station 105 may schedule sidelink transmissions to avoid resource collisions).

In examples in which the UEs 115 communicate in accordance with the V2X Mode-2, the UEs 115 may determine (e.g., without scheduling information from the base station 105) one or more sidelink transmission resources within a set of sidelink resources that are configured by the base station 105 or the network or a set of sidelink resources that are pre-configured (e.g., preloaded at the UEs 115). In such examples, a transmitting UE 115 may sense and select resources based on a number of SCI-1 messages and reference signal receive power (RSRP) measurements of a DM-RS inside the PSSCH 225 or the PSCCH 220. Further, a transmitting UE 115 may use SCI-1 in the PSCCH 220 and SCI-2 in the PSSCH 225 to schedule and transmit a data message inside the PSSCH 225. The transmitting UE 115 may perform sidelink transmissions using various cast types, including unicast signaling, groupcast signaling, or broadcast signaling. A receiving UE 115 may transmit feedback, such as acknowledgment (ACK) or negative-ACK (NACK) feedback, on the PSFCH 235 based on receiving a sidelink transmission. For example, the receiving UE 115 may transmit explicit ACK/NACK feedback for (e.g., responsive to) unicast signaling or groupcast signaling or may transmit NACK for (e.g., responsive to) groupcast signaling.

In some examples, a transmitting UE 115 may refrain from scrambling the PSCCH 220 (e.g., including SCI-1) such that various other sidelink UEs 115 may be able to decode the PSCCH 220. In other words, for example, the PSCCH 220 (e.g., the SCI-1) may be unscrambled and may be decoded by any UE 115 that receives the PSCCH 220 (e.g., any UE 115 in range of or within a coverage area associated with the transmitting UE 115). As such, a receiving sidelink UE 115 may receive one or more SCI-1 messages, decode each of the one or more SCI-1 messages, and may use the decoded SCI-1 messages to perform channel sensing and thus to avoid a resource collision (which may be especially useful in Mode 2 operation). SCI-1, however, may not include a destination ID associated with an intended receiver. As such, each (if not all) sidelink UEs 115 able to receive the SCI-1 may also decode a corresponding PSSCH 225 (e.g., the PSSCH 225 scheduled by the SCI-1 message) to determine whether a data message sent over the PSSCH 225 is intended for that UE 115.

As a result, a decoding effort for PSSCH messages that are not intended for the decoding UE 115 may be wasted (especially in Mode 1 operation, as the UE 115 may also refrain from using the PSSCH 225 for channel sensing). For example, a receiving UE 115 may receive and decode the SCI-1 scheduling a message over the PSSCH 225 and, in cases in which the SCI-1 lacks a destination ID, the receiving UE 115 may also receive and decode the PSSCH 225 for SCI-2 and the message. If the receiving UE 115 decodes a destination ID in the SCI-2 that is non-matching with a destination ID associated with the receiving UE 115, the receiving UE 115 may determine that the receiving UE 115 is not an intended receiver of the message. The receiving UE 115, however, has already decoded the PSSCH 225, and such decoding may be wasted or unnecessary due to the receiving UE 115 not being an intended receiver. Mode 1 operation may further increase the perceived waste of decoding resources, as the receiving UE 115 may also refrain from using the PSSCH 225 for channel sensing.

In some implementations, the UEs 115 in the wireless communications system 200 may support an SCI-1 format that is based on a destination filter indicator or a destination filter indication associated with one or more intended receivers of a message scheduled by the SCI-1 such that a receiving UE 115 may filter out (e.g., refrain from decoding) PSSCH messages that are not intended for itself. As such, the receiving UE 115 may refrain from decoding filtered PSSCH messages, which may lower a decoding overhead at the receiving UE 115 as the receiving UE 115 avoids (or reduce the likelihood of) scenarios in which the receiving UE 115 decodes a PSSCH 225 including a data message for which the UE 115 is not an intended receiver. For example, for I-IoT traffic under Mode 1 operation (unlike in Mode 2 operation), not every UE 115 may perform channel sensing and hence some UEs 115 may refrain from decoding all PSCCH 220 and corresponding PSSCH messages. Therefore, reducing a number of PSSCH decoding occasions to decrease decoding overhead is achievable for Mode 1 operation.

A format of the destination filter indicator in SCI-1 may take various forms, but each form may influence how a transmitting UE organizes or transmits the SCI-1. In some examples, the transmitting UE 115 may transmit an indication of the destination filter indicator in SCI-1 via a number of bits. In other words, for example, a fixed number of bits of SCI-1 may be dedicated to destination filtering and may carry the destination filter indicator. In some implementations, the fixed number of bits may include or convey a subset of bits of a destination ID. In such implementations, the subset of bits of the destination ID may be the destination filter indicator and UEs 115 associated with a non-matching subset of destination ID may refrain from decoding the corresponding PSSCH 225. Such a subset of destination ID may include an initial or leading number of bits of a destination ID or a last or final number of bits of the destination ID. In some additional or alternative implementations, the fixed number of bits may include or convey a hash function of destination ID. In such implementations, the hash function of the destination ID may be the destination filter indicator and UEs with destination IDs that do not match the hash may refrain from decoding the corresponding PSSCH 225.

In some additional or alternative implementations, the fixed number of bits may include or convey a subset of bits or a hash function of a source ID associated with the transmitting UE 115. In such implementations, the destination filter indicator may be one or both of the subset of bits of the source ID or the hash function of the source ID and UEs 115 not expecting communication from the source ID may refrain from decoding the corresponding PSSCH 225. Such use of the subset of bits of the source ID or the hash function of the source ID as the destination filter indicator may be useful if the transmitting UE 115 (e.g., a source) communicates with a single receiving UE 115 (e.g., a single destination). Further, such a subset of source ID may include an initial or leading number of bits of a source ID or a last or final number of bits of the source ID. In some additional or alternative implementations, the fixed number of bits may include or convey a complete destination ID or a complete source ID. In such implementations, the destination filter indicator may be one or both of the complete destination ID or the complete source ID and UEs 115 associated with non-matching destination IDs or not expecting communication from the source ID may refrain from decoding the corresponding PSSCH 225.

In addition or as an alternative to conveying the destination filter indicator via a number of bits in SCI-1, the transmitting UE 115 may scramble one or more CRC bits of the SCI-1 based on the destination filter indicator or based on an ID associated with the destination filter indicator. In such examples in which the transmitting UE 115 scrambles the one or more CRC bits of the SCI-1 based on the destination filter indicator, receiving UEs 115 that lack or otherwise do not possess a matching destination filter indicator may be unable to successfully perform an error check for the SCI-1 and may skip decoding the corresponding PSSCH 225. In some aspects, the destination filter indicator or the ID associated with the destination filter indicator on which the scrambling of the CRC bits of the SCI-1 is based may include or be an example of an SL-filter-RNTI. In some implementations, multiple SL-filter-RNTIs may exist (such that the transmitting UE 115 may select one of the multiple based on the intended receivers of the corresponding PSSCH 225). In some aspects, each SL-filter-RNTI may be shared by a group of UEs. Each SL-filter-RNTI may be preconfigured by upper layer signaling, such as by RRC signaling, from another UE 115 or the base station 105. In some additional or alternative implementations, an SL-filter-RNTI may be a function of a destination ID associated with the one or more intended receivers.

In some examples, the transmitting UE 115 may scramble the CRC of SCI-1 based on a sidelink filter RNTI, which may be referred to as an SL-filter-RNTI, in order to provide a destination filter indication. For example, a UE 115 that does not possess the SL-filter-RNTI may be unable to descramble the CRC and may skip decoding the corresponding PSSCH 225. As such, a receiving UE 115 may decode the SCI-1 and perform an error check for the SCI-1 using a destination filter indicator associated with the receiving UE 115 and if the error check fails, the UE 115 may refrain from decoding the corresponding PSSCH 225. Alternatively, if the error check for the SCI-1 passes, the receiving UE 115 may determine that the receiving UE 115 may be an intended receiver for the corresponding PSSCH 225 (e.g., based on a correlation between matching destination filter indicators and successful CRC checks for SCI-1) and may decode the PSSCH 225.

In some implementations, the inclusion of destination filter indicator within the SCI-1 or the scrambling of CRC bits of the SCI-1 based on the destination filter indicator may enable a re-configuration (e.g., a simplification) of SCI-2. In some examples, for instance, given the destination filtering indication via the SCI-1, one or more bits of a destination ID included in the SCI-2 may be redundant. For example, if the transmitting UE 115 includes a subset of bits (e.g., the first few bits or the last few bits) of a destination ID in the SCI-1 for destination filtering, the transmitting UE 115 may omit that subset of bits of the destination ID in the SCI-2. In other words, the transmitting UE 115 may format the SCI-2 to omit any redundant bits of the destination ID. Additionally or alternatively, given the destination filtering indication via the SCI-1, the transmitting UE 115 may format the SCI-2 to include a hash function of the destination ID in the destination ID field of the SCI-2. In other words, the transmitting UE 115 may replace the destination ID in the SCI-2 with a hash function of the destination ID or may otherwise compress the destination ID in the SCI-2 to make room for the hash function of the destination ID. Such use of a hash function instead of the complete destination ID in the SCI-2 may be useful if the hash function and the destination filtering indication together uniquely determine or identify the destination ID associated with the one or more intended receivers.

Further, in some implementations, the transmitting UE 115 may leverage the destination filtering via SCI-1 to reduce a length of the SCI-1. For example, some fields in SCI-1, such as a priority field and time and frequency resource assignment fields, may be designed for Mode 2 operation to support channel sensing. In Mode 1 operation, those fields may be deferred to SCI-2, which may lower a decoding overhead of the SCI-1 for any receiving UEs 115 (e.g., as each of a number of receiving UEs 115 may decode SCI-1, but SCI-2 decoding is facilitated by destination filtering). As such, although the transmitting UE 115 may introduce an extra destination filtering indicator in SCI-1, the transmitting UE 115 may defer some fields that are sometimes included in SCI-1 to SCI-2 to minimize or otherwise reduce the length of the SCI-1 (which may be decoded by every UE 115).

Accordingly, in some implementations, the transmitting UE 115 may format the SCI-1 and the SCI-2 to effectively swap the time and frequency resource assignment fields in SCI-1 with the destination ID field in SCI-2 and replace the destination ID (which is in SCI-1 according to the formatting) with a destination filtering indicator field. In such implementations, if a length of the destination filtering indicator field is less than or equal to (e.g., does not exceed) a combined length of the time and frequency resource assignment fields, the transmitting UE 115 may avoid increasing the length of the SCI-1. Accordingly, each receiving UE 115 may refrain from decoding the time and frequency resource assignment fields in SCI-1 (which may potentially be irrelevant to that receiving UE 115 depending on the destination filtering indicator), which may decrease the decoding overhead associated with the SCI-1.

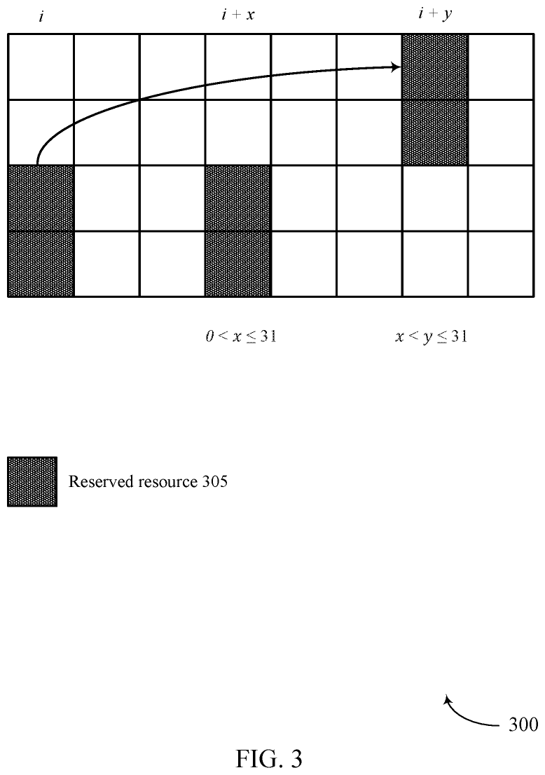

FIG. 3 illustrates an example of a resource reservation scheme 300 that supports techniques for destination filtering in SCI-1 in accordance with aspects of the present disclosure. The resource reservation scheme 300 may implement or be implemented to realize aspects of the wireless communications system 100 or the wireless communications system 200. In some examples, a transmitting UE 115 (which may be an example of a UE 115 as described with reference to FIGS. 1 and 2) may reserve resources for one, two, or three sidelink transmissions via SCI-1 (e.g., for sidelink resource reservation via dynamic grant). For example, the transmitting UE 115 may signal a reservation for up to three sidelink transmissions and may reserve, for each sidelink transmission, a number of sub-channels z in a slot relative to a slot i during which the transmitting UE 115 transmits the SCI-1, as shown in Table 1 below.

TABLE 1
Reservations Signaled by an SCI in Slot i

| Reservation | # of Sub-Channels | Slot |
|---|---|---|
| 1 | z | i |
| 2 | z | i + x: 0 < x ≤ 31 |
| 3 | z | i + y: x < y ≤ 31 |

Table 1 represents a reservation of slots and sub-channels in accordance with aspects of resource reservation scheme 300. In some implementations, the first reservation may start right away (e.g., during the same slot i as the transmitting UE 115 transmit the SCI-1) and the transmitting UE 115 may reserve a same number of sub-channels z for each resource reservation. As illustrated in Table 1 and in FIG. 3, the transmitting UE 115 may also reserve a slot i+x and a slot i+y and starting sub-channels can differ between reservations. In some aspects, a value for x and y may be constrained by some number, factor, or variable. For example, the transmitting UE 115 may define x such that 0<x≤31 and may define y such that x<y≤31.

In some examples, a receiving UE 115 may receive the SCI-1 and identify the resources reserved by the SCI-1 as a result of decoding the SCI-1. In some implementations, the UE may decode the SCI-1 during slot i and may determine, based on a destination filtering indicator associated with the SCI-1, that corresponding PSSCH data carried over reserved resources 305 is not intended for the receiving UE 115 based on the destination filtering indicator. In such implementations, the receiving UE 115 may refrain from decoding the PSSCH data carried over the reserved resources 305.

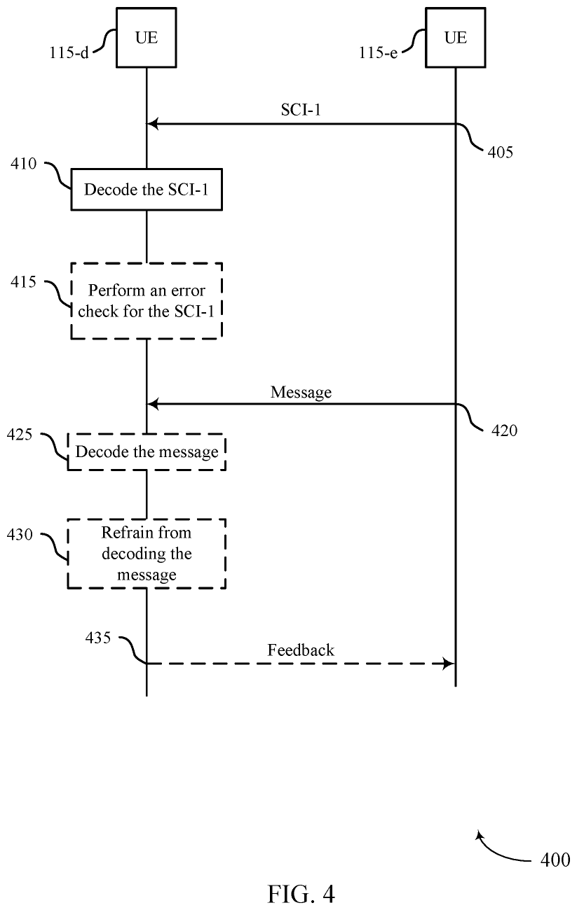

FIG. 4 illustrates an example of a process flow 400 that supports techniques for destination filtering in SCI-1 in accordance with aspects of the present disclosure. The process flow 400 may implement or be implemented to realize aspects of the wireless communications system 100 or the wireless communications system 200. For example, the process flow 400 illustrates communication between a UE 115-d (e.g., a first or receiving UE 115) and a UE 115-e (e.g., a second or transmitting UE 115) in a sidelink network, and the UE 115-d and the UE 115-e may be examples of UEs 115 as described with reference to FIGS. 1 through 3.

In the following description of the process flow 400, the operations may be performed (such as reported or provided) in a different order than the order shown, or the operations performed by the example devices may be performed in different orders or at different times. Some operations also may be left out of the process flow 400, or other operations may be added to the process flow 400. Further, although some operations or signaling may be shown to occur at different times for discussion purposes, these operations may actually occur at the same time.

At 405, the UE 115-d may receive, from the UE 115-e over a sidelink control channel (e.g., a PSCCH), SCI-1 that is based on a first destination filter indicator associated with one or more intended receivers of a message scheduled by the SCI-1. In some examples, the SCI-1 may include a first portion of SCI associated with scheduling the message, where SCI-2 may include a second portion of the SCI associated with scheduling the message. In some implementations, the UE 115-e may transmit the SCI-1 including an explicit indication of the first destination filter indicator associated with the one or more intended receivers (e.g., via a number of bits). Additionally or alternatively, the UE 115-e may transmit the SCI-1 including an implicit indication of the first destination filter indicator associated with the one or more intended receivers (e.g., based on scrambling one or more CRC bits of the SCI-1 based on the first destination filter indicator or based on a first ID associated with the first destination filter indicator).

At 410, the UE 115-d may decode the SCI-1 based on a second destination filter indicator associated with the UE 115-d. For example, the UE 115-d may decode the SCI-1 and, in some examples, the SCI-1 may indicate (e.g., either explicitly or implicitly) the first destination filter indicator associated with the one or more intended receivers of the message scheduled by the SCI-1 and, as part of the decoding of the SCI-1, the UE 115-d may compare (e.g., either directly or indirectly) the second destination filter indicator associated with the UE 115-d with the first destination filter indicator associated with the one or more intended receivers. In some implementations, for instance, the SCI-1 may include an indication of the first destination filter indicator (e.g., via a number of bits) and the UE 115-d may directly compare the second destination filter indicator with the first destination filter indicator as part of the decoding. For example, the UE 115-d may read the first destination filter indicator from the SCI-1 and may determine that the UE 115-d is an intended receiver of the message if the second destination filter indicator and the first destination filter indicator are a same destination filter indicator. Alternatively, the UE 115-d may determine that the UE 115-d is not an intended receiver of the message if the second destination filter indicator and the first destination filter indicator are different.

At 415, the UE 115-d may, in some implementations, perform an error check (e.g., a CRC check) for the SCI-1 using the second destination filter indicator or a second ID associated with the second destination filter indicator. In such implementations, the UE 115-e may scramble the CRC bits of the SCI-1 based on the first destination filter indicator or based on the first ID associated with the first destination filter indicator and the UE 115-d may indirectly compare the second destination filter indicator associated with the UE 115-d with the first destination filter indicator associated with the one or more intended receivers via the performing of the error check. For example, if the UE 115-d passes the error check, the UE 115-d may determine that the second destination filter indicator and the first destination filter indicator are a same destination filter indicator and that the UE 115-d is an intended receiver of the message. Alternatively, if the UE 115-d fails the error check, the UE 115-d may determine that the second destination filter indicator and the first destination filter indicator are different and that the UE 115-d is not an intended receiver of the message.

At 420, the UE 115-e may transmit the message scheduled by the SCI-1. The UE 115-d may receive the message scheduled by the SCI-1 based on the first destination filter indicator and the second destination filter indicator. For example, the UE 115-d may receive the message and may determine whether to decode the message based on whether the first destination filter indicator and the second destination filter indicator are the same. In some aspects, the message may include any message sent over a PSSCH, such as one or both of SCI-2 or a data message.

At 425, the UE 115-d may, in some implementations, decode the message scheduled by the SCI-1 based on the first destination filter indicator and the second destination filter indicator being the same destination filter indicator. For example, if the UE 115-d determines that the first destination filter indicator and the second destination filter indicator are the same destination filter indicator, the UE 115-d may determine that the UE 115-d is an intended receiver of the message and may decode the message.

At 430, the UE 115-d may, in some implementations, refrain from decoding the message scheduled by the SCI-1 based on the first destination filter indicator and the second destination filter indicator being different destination filter indicators. For example, if the UE 115-d determines that the first destination filter indicator and the second destination filter indicator are different or non-matching, the UE 115-d may determine that the UE 115-d is not an intended receiver of the message and may refrain from decoding the message.

At 435, the UE 115-d may, in some implementations, transmit feedback to the UE 115-e. For example, in implementations in which the UE 115-d is an intended receiver of the message and decodes the message at 425, the UE 115-d may transmit feedback to the UE 115-e over a PSFCH resource indicating whether the UE 115-d successfully decoded the message.

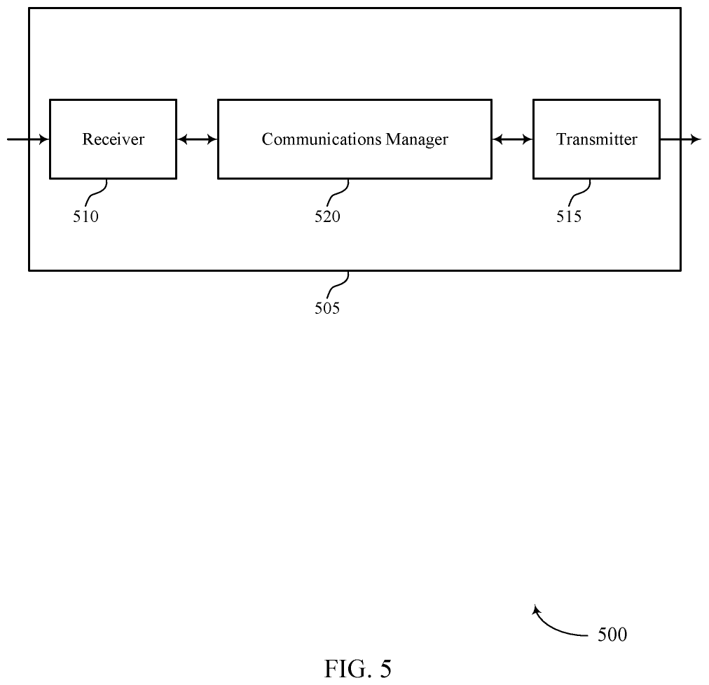

FIG. 5 shows a block diagram 500 of a device 505 that supports techniques for destination filtering in SCI-1 in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for destination filtering in SCI-1). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for destination filtering in SCI-1). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for destination filtering in SCI-1 as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first UE in accordance with examples as disclosed herein. For example, the communications manager 520 may be configured as or otherwise support a means for receiving, from a second UE over a sidelink control channel, SCI-1 that is based on a first destination filter indicator associated with one or more intended receivers of a message scheduled by the SCI-1, the SCI-1 including a first portion of SCI associated with scheduling the message. The communications manager 520 may be configured as or otherwise support a means for decoding the SCI-1 based on a second destination filter indicator associated with the first UE. The communications manager 520 may be configured as or otherwise support a means for receiving the message scheduled by the SCI-1 based on the first destination filter indicator and the second destination filter indicator.

Additionally or alternatively, the communications manager 520 may support wireless communication at a second UE in accordance with examples as disclosed herein. For example, the communications manager 520 may be configured as or otherwise support a means for receiving scheduling information for a message to be transmitted to at least a first UE. The communications manager 520 may be configured as or otherwise support a means for transmitting, over a sidelink control channel, SCI-1 that is based on a destination filter indicator associated with one or more intended receivers of the message including at least the first UE, the SCI-1 including a first portion of SCI associated with scheduling the message. The communications manager 520 may be configured as or otherwise support a means for transmitting the message according to the received scheduling information, the transmitting of the message based on the SCI-1.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, and more efficient utilization of communication resources.

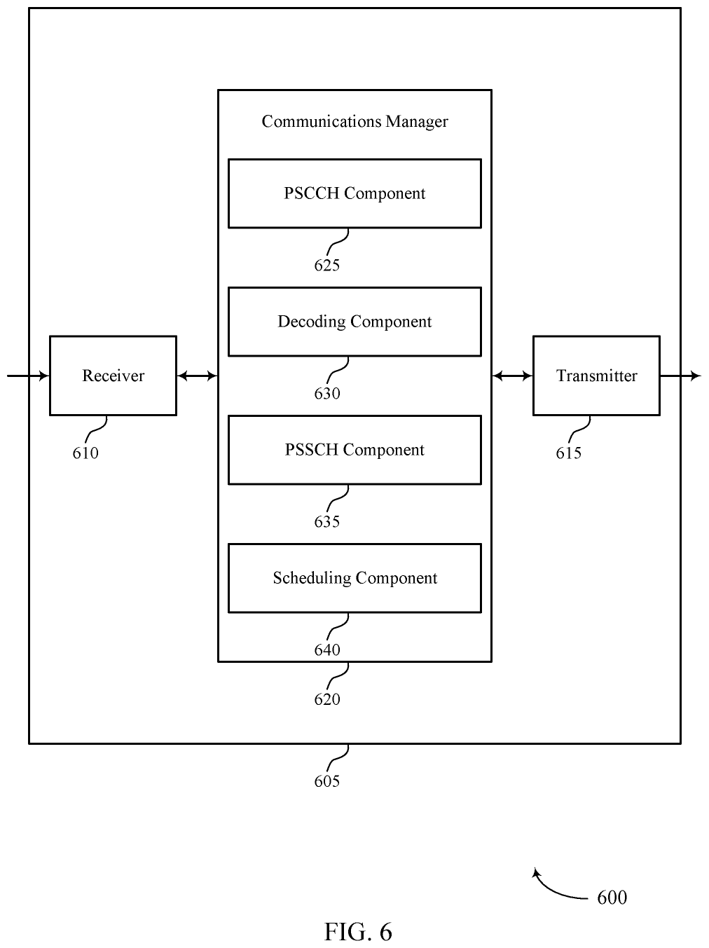

FIG. 6 shows a block diagram 600 of a device 605 that supports techniques for destination filtering in SCI-1 in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for destination filtering in SCI-1). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for destination filtering in SCI-1). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for destination filtering in SCI-1 as described herein. For example, the communications manager 620 may include an PSCCH component 625, a decoding component 630, an PSSCH component 635, a scheduling component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first UE in accordance with examples as disclosed herein. The PSCCH component 625 may be configured as or otherwise support a means for receiving, from a second UE over a sidelink control channel, SCI-1 that is based on a first destination filter indicator associated with one or more intended receivers of a message scheduled by the SCI-1, the SCI-1 including a first portion of SCI associated with scheduling the message. The decoding component 630 may be configured as or otherwise support a means for decoding the SCI-1 based on a second destination filter indicator associated with the first UE. The PSSCH component 635 may be configured as or otherwise support a means for receiving the message scheduled by the SCI-1 based on the first destination filter indicator and the second destination filter indicator.

Additionally or alternatively, the communications manager 620 may support wireless communication at a second UE in accordance with examples as disclosed herein. The scheduling component 640 may be configured as or otherwise support a means for receiving scheduling information for a message to be transmitted to at least a first UE. The PSCCH component 625 may be configured as or otherwise support a means for transmitting, over a sidelink control channel, SCI-1 that is based on a destination filter indicator associated with one or more intended receivers of the message including at least the first UE, the SCI-1 including a first portion of SCI associated with scheduling the message. The PSSCH component 635 may be configured as or otherwise support a means for transmitting the message according to the received scheduling information, the transmitting of the message based on the SCI-1.

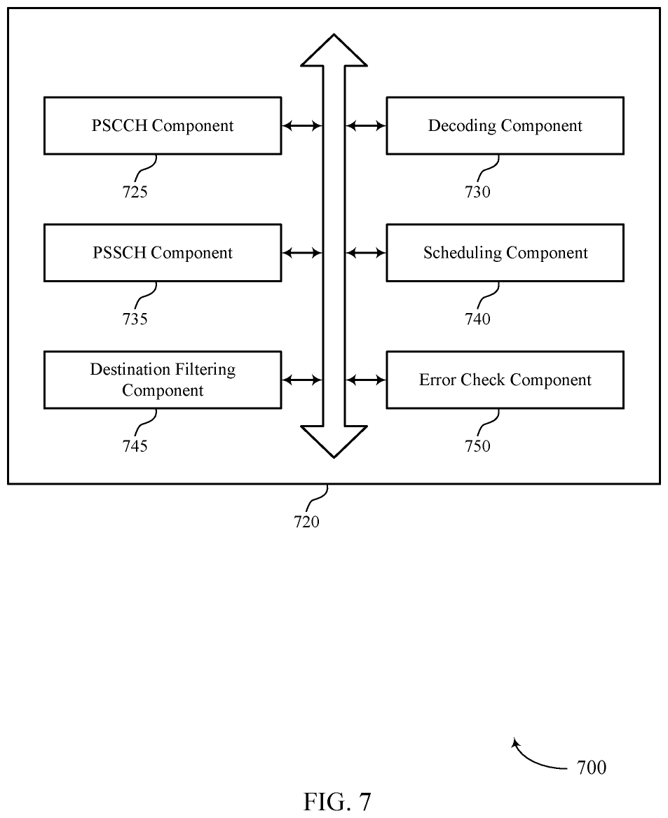

FIG. 7 shows a block diagram 700 of a communications manager 720 that supports techniques for destination filtering in SCI-1 in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for destination filtering in SCI-1 as described herein. For example, the communications manager 720 may include an PSCCH component 725, a decoding component 730, an PSSCH component 735, a scheduling component 740, a destination filtering component 745, an error check component 750, or any combination thereof. Each of these components may communicate, directly or indirectly, with one another (e.g., via one or more buses).

The communications manager 720 may support wireless communication at a first UE in accordance with examples as disclosed herein. The PSCCH component 725 may be configured as or otherwise support a means for receiving, from a second UE over a sidelink control channel, SCI-1 that is based on a first destination filter indicator associated with one or more intended receivers of a message scheduled by the SCI-1, the SCI-1 including a first portion of SCI associated with scheduling the message. The decoding component 730 may be configured as or otherwise support a means for decoding the SCI-1 based on a second destination filter indicator associated with the first UE. The PS SCH component 735 may be configured as or otherwise support a means for receiving the message scheduled by the SCI-1 based on the first destination filter indicator and the second destination filter indicator.

In some examples, the first destination filter indicator and the second destination filter indicator are a same destination filter indicator, and the decoding component 730 may be configured as or otherwise support a means for decoding the message scheduled by the SCI-1 based on the first destination filter indicator and the second destination filter indicator being the same destination filter indicator.

In some examples, the SCI-1 includes an indication of the first destination filter indicator, and the destination filtering component 745 may be configured as or otherwise support a means for determining that the first destination filter indicator and the second destination filter indicator are the same destination filter indicator based on decoding the SCI-1, where decoding the message is based on determining that the first destination filter indicator and the second destination filter indicator are the same destination filter indicator.

In some examples, the SCI-1 includes one or more CRC bits that are scrambled by a first ID associated with the first destination filter indicator, and the error check component 750 may be configured as or otherwise support a means for performing an error check for the SCI-1 using a second ID associated with the second destination filter indicator. In some examples, the SCI-1 includes one or more CRC bits that are scrambled by a first ID associated with the first destination filter indicator, and the error check component 750 may be configured as or otherwise support a means for passing the error check based on the first ID and the second ID being a same ID, where decoding the message is based on passing the error check.

In some examples, the first destination filter indicator and the second destination filter indicator are different destination filter indicators, and the decoding component 730 may be configured as or otherwise support a means for refraining from decoding the message scheduled by the SCI-1 based on the first destination filter indicator and the second destination filter indicator being different destination filter indicators.

In some examples, the SCI-1 includes the first destination filter indicator, and the destination filtering component 745 may be configured as or otherwise support a means for determining that the first destination filter indicator is different from the second destination filter indicator based on decoding the SCI-1, where refraining from decoding the message is based on determining that the first destination filter indicator is different from the second destination filter indicator.

In some examples, the SCI-1 includes one or more CRC bits that are scrambled by a first ID associated with the first destination filter indicator, and the error check component 750 may be configured as or otherwise support a means for performing an error check for the SCI-1 using a second ID associated with the second destination filter indicator. In some examples, the SCI-1 includes one or more CRC bits that are scrambled by a first ID associated with the first destination filter indicator, and the error check component 750 may be configured as or otherwise support a means for failing the error check based on the first ID being different from the second ID, where refraining from decoding the message is based on failing the error check.

In some examples, the PSSCH component 735 may be configured as or otherwise support a means for receiving SCI-2 associated with the message, the SCI-2 including a subset of a destination ID or a hash function of the destination ID. In some examples, the subset of the destination ID or the hash function of the destination ID uniquely identifies the one or more intended receivers in combination with the first destination filter indicator associated with the SCI-1.

In some examples, the SCI-1 includes an indication of the first destination filter indicator, and the PSSCH component 735 may be configured as or otherwise support a means for receiving SCI-2 including a time and frequency resource assignment for the message based on the SCI-1 including the first destination filter indicator. In some examples, to support receiving the SCI-1 that is based on the first destination filter indicator, the destination filtering component 745 may be configured as or otherwise support a means for receiving an indication of the first destination filter indicator via a quantity of bits in the SCI-1.

In some examples, the quantity of bits include a subset of a destination ID associated with the one or more intended receivers or a hash function of the destination ID associated with the one or more intended receivers. In some examples, the quantity of bits include a subset of a source ID associated with the second UE or a hash function of the source ID associated with the second UE.

In some examples, the quantity of bits include a complete destination ID associated with the one or more intended receivers or a complete source ID associated with the second UE. In some examples, the second UE and the first UE communicate in accordance with a sidelink resource allocation Mode 1.

Additionally or alternatively, the communications manager 720 may support wireless communication at a second UE in accordance with examples as disclosed herein. The scheduling component 740 may be configured as or otherwise support a means for receiving scheduling information for a message to be transmitted to at least a first UE. In some examples, the PSCCH component 725 may be configured as or otherwise support a means for transmitting, over a sidelink control channel, SCI-1 that is based on a destination filter indicator associated with one or more intended receivers of the message including at least the first UE, the SCI-1 including a first portion of SCI associated with scheduling the message. In some examples, the PSSCH component 735 may be configured as or otherwise support a means for transmitting the message according to the received scheduling information, the transmitting of the message based on the SCI-1.

In some examples, the PSSCH component 735 may be configured as or otherwise support a means for transmitting SCI-2 associated with the message, the SCI-2 including a subset of a destination ID associated with at least the first UE or a hash function of the destination ID associated with at least the first UE. In some examples, the subset of the destination ID associated with at least the first UE or the hash function of the destination ID associated with at least the first UE uniquely identifies at least the first UE in combination with the destination filter indicator associated with the SCI-1.

In some examples, the SCI-1 includes an indication of the destination filter indicator, and the PSSCH component 735 may be configured as or otherwise support a means for transmitting SCI-2 including a time and frequency resource assignment for the message based on the SCI-1 including the destination filter indicator.

In some examples, to support transmitting the SCI-1 that is based on the destination filter indicator associated with at least the first UE, the destination filtering component 745 may be configured as or otherwise support a means for transmitting the destination filter indicator via a quantity of bits in the SCI-1.

In some examples, the quantity of bits include a subset of a destination ID associated with the first UE or a hash function of the destination ID associated with the first UE. In some examples, the quantity of bits include a subset of a source ID associated with the second UE or a hash function of the source ID associated with the second UE. In some examples, the quantity of bits include a complete destination ID associated with the first UE or a complete source ID associated with the second UE.

In some examples, to support transmitting the SCI-1 that is based on the destination filter indicator associated with the first UE, the error check component 750 may be configured as or otherwise support a means for transmitting one or more CRC bits that are scrambled by an ID associated with the destination filter indicator. In some examples, the ID is shared by a group of UEs including at least the first UE or is a function of a destination ID associated with at least the first UE.

In some examples, to support receiving the scheduling information for the message to be transmitted to at least the first UE, the scheduling component 740 may be configured as or otherwise support a means for receiving the scheduling information from a base station, where the second UE and at least the first UE communicate in accordance with a sidelink resource allocation Mode 1.

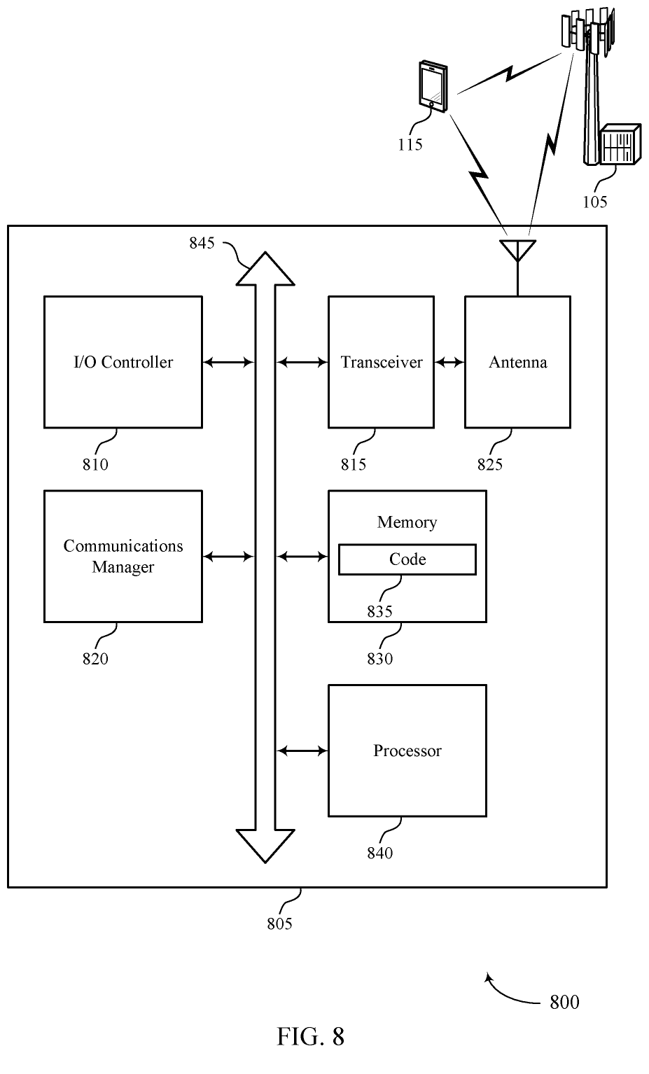

FIG. 8 shows a diagram of a system 800 including a device 805 that supports techniques for destination filtering in SCI-1 in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for destination filtering in SCI-1). For example, the device 805 or a component of the device 805 may include a processor 840 and memory 830 coupled to the processor 840, the processor 840 and memory 830 configured to perform various functions described herein.

The communications manager 820 may support wireless communication at a first UE in accordance with examples as disclosed herein. For example, the communications manager 820 may be configured as or otherwise support a means for receiving, from a second UE over a sidelink control channel, SCI-1 that is based on a first destination filter indicator associated with one or more intended receivers of a message scheduled by the SCI-1, the SCI-1 including a first portion of SCI associated with scheduling the message. The communications manager 820 may be configured as or otherwise support a means for decoding the SCI-1 based on a second destination filter indicator associated with the first UE. The communications manager 820 may be configured as or otherwise support a means for receiving the message scheduled by the SCI-1 based on the first destination filter indicator and the second destination filter indicator.

Additionally or alternatively, the communications manager 820 may support wireless communication at a second UE in accordance with examples as disclosed herein. For example, the communications manager 820 may be configured as or otherwise support a means for receiving scheduling information for a message to be transmitted to at least a first UE. The communications manager 820 may be configured as or otherwise support a means for transmitting, over a sidelink control channel, SCI-1 that is based on a destination filter indicator associated with one or more intended receivers of the message including at least the first UE, the SCI-1 including a first portion of SCI associated with scheduling the message. The communications manager 820 may be configured as or otherwise support a means for transmitting the message according to the received scheduling information, the transmitting of the message based on the SCI-1.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for destination filtering in SCI-1 as described herein, or the processor 840 and the memory 830 may be otherwise configured to perform or support such operations.

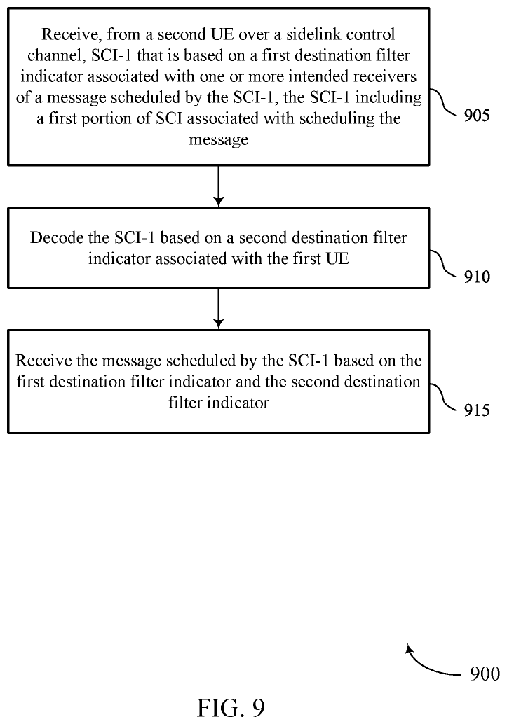

FIG. 9 shows a flowchart illustrating a method 900 that supports techniques for destination filtering in SCI-1 in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include receiving, from a second UE over a sidelink control channel, SCI-1 that is based on a first destination filter indicator associated with one or more intended receivers of a message scheduled by the SCI-1, the SCI-1 including a first portion of SCI associated with scheduling the message. The operations of 905 may be performed in accordance with examples as disclosed herein. In some examples, aspects of the operations of 905 may be performed by an PSCCH component 725 as described with reference to FIG. 7.

At 910, the method may include decoding the SCI-1 based on a second destination filter indicator associated with the first UE. The operations of 910 may be performed in accordance with examples as disclosed herein. In some examples, aspects of the operations of 910 may be performed by a decoding component 730 as described with reference to FIG. 7.

At 915, the method may include receiving the message scheduled by the SCI-1 based on the first destination filter indicator and the second destination filter indicator. The operations of 915 may be performed in accordance with examples as disclosed herein. In some examples, aspects of the operations of 915 may be performed by an PSSCH component 735 as described with reference to FIG. 7.

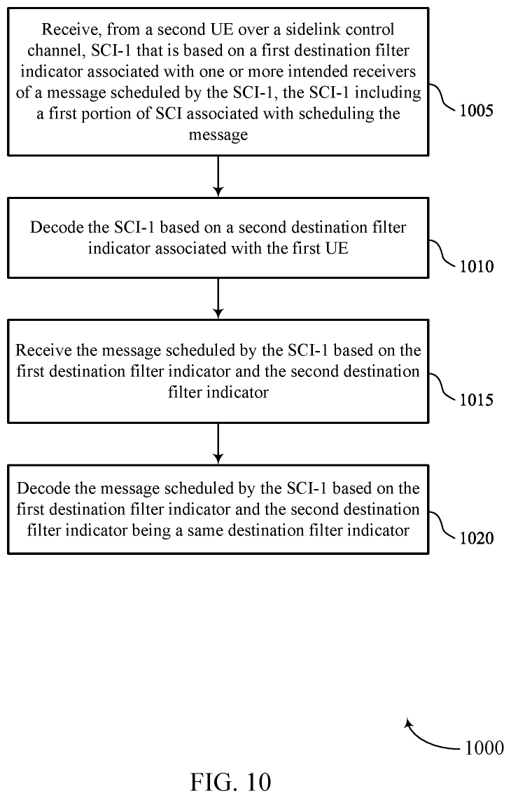

FIG. 10 shows a flowchart illustrating a method 1000 that supports techniques for destination filtering in SCI-1 in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include receiving, from a second UE over a sidelink control channel, SCI-1 that is based on a first destination filter indicator associated with one or more intended receivers of a message scheduled by the SCI-1, the SCI-1 including a first portion of SCI associated with scheduling the message. The operations of 1005 may be performed in accordance with examples as disclosed herein. In some examples, aspects of the operations of 1005 may be performed by an PSCCH component 725 as described with reference to FIG. 7.

At 1010, the method may include decoding the SCI-1 based on a second destination filter indicator associated with the first UE. The operations of 1010 may be performed in accordance with examples as disclosed herein. In some examples, aspects of the operations of 1010 may be performed by a decoding component 730 as described with reference to FIG. 7.

At 1015, the method may include receiving the message scheduled by the SCI-1 based on the first destination filter indicator and the second destination filter indicator. The operations of 1015 may be performed in accordance with examples as disclosed herein. In some examples, aspects of the operations of 1015 may be performed by an PSSCH component 735 as described with reference to FIG. 7.

At 1020, the method may include decoding the message scheduled by the SCI-1 based on the first destination filter indicator and the second destination filter indicator being a same destination filter indicator. The operations of 1020 may be performed in accordance with examples as disclosed herein. In some examples, aspects of the operations of 1020 may be performed by a decoding component 730 as described with reference to FIG. 7.

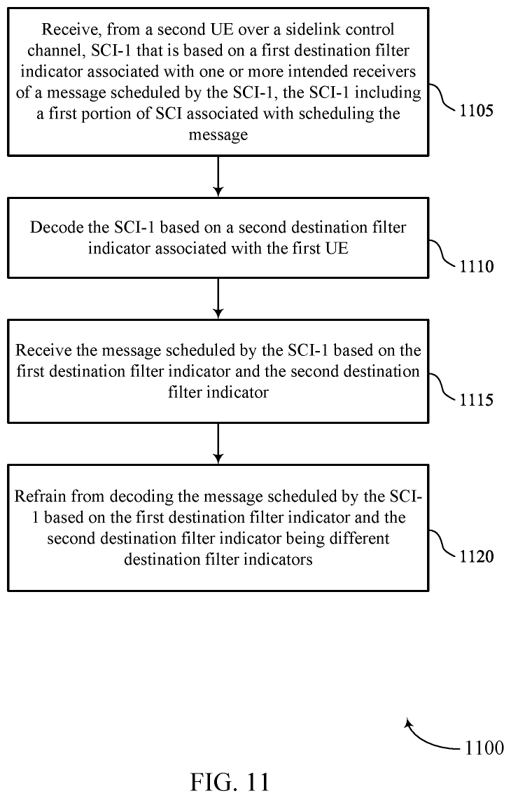

FIG. 11 shows a flowchart illustrating a method 1100 that supports techniques for destination filtering in SCI-1 in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include receiving, from a second UE over a sidelink control channel, SCI-1 that is based on a first destination filter indicator associated with one or more intended receivers of a message scheduled by the SCI-1, the SCI-1 including a first portion of SCI associated with scheduling the message. The operations of 1105 may be performed in accordance with examples as disclosed herein. In some examples, aspects of the operations of 1105 may be performed by an PSCCH component 725 as described with reference to FIG. 7.

At 1110, the method may include decoding the SCI-1 based on a second destination filter indicator associated with the first UE. The operations of 1110 may be performed in accordance with examples as disclosed herein. In some examples, aspects of the operations of 1110 may be performed by a decoding component 730 as described with reference to FIG. 7.

At 1115, the method may include receiving the message scheduled by the SCI-1 based on the first destination filter indicator and the second destination filter indicator. The operations of 1115 may be performed in accordance with examples as disclosed herein. In some examples, aspects of the operations of 1115 may be performed by an PSSCH component 735 as described with reference to FIG. 7.

At 1120, the method may include refraining from decoding the message scheduled by the SCI-1 based on the first destination filter indicator and the second destination filter indicator being different destination filter indicators. The operations of 1120 may be performed in accordance with examples as disclosed herein. In some examples, aspects of the operations of 1120 may be performed by a decoding component 730 as described with reference to FIG. 7.

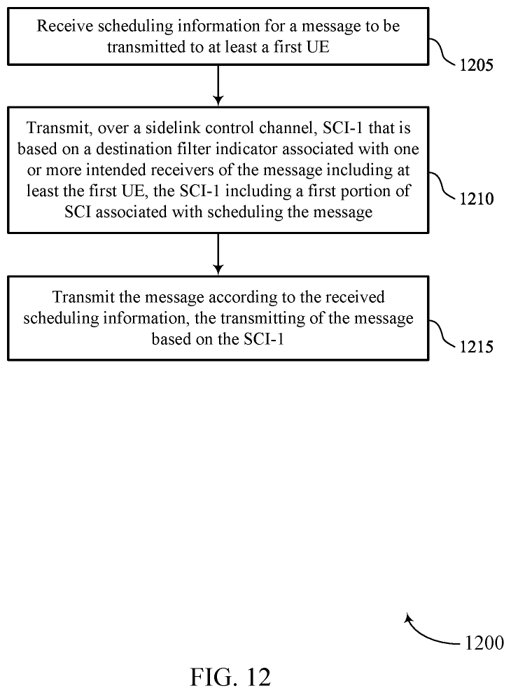

FIG. 12 shows a flowchart illustrating a method 1200 that supports techniques for destination filtering in SCI-1 in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1205, the method may include receiving scheduling information for a message to be transmitted to at least a first UE. The operations of 1205 may be performed in accordance with examples as disclosed herein. In some examples, aspects of the operations of 1205 may be performed by a scheduling component 740 as described with reference to FIG. 7.

At 1210, the method may include transmitting, over a sidelink control channel, SCI-1 that is based on a destination filter indicator associated with one or more intended receivers of the message including at least the first UE, the SCI-1 including a first portion of SCI associated with scheduling the message. The operations of 1210 may be performed in accordance with examples as disclosed herein. In some examples, aspects of the operations of 1210 may be performed by an PSCCH component 725 as described with reference to FIG. 7.

At 1215, the method may include transmitting the message according to the received scheduling information, the transmitting of the message based on the SCI-1. The operations of 1215 may be performed in accordance with examples as disclosed herein. In some examples, aspects of the operations of 1215 may be performed by an PSSCH component 735 as described with reference to FIG. 7.

The following provides an overview of aspects of the present disclosure:

Aspect 1: A method for wireless communication at a first UE, comprising: receiving, from a second UE over a sidelink control channel, SCI-1 that is based at least in part on a first destination filter indicator associated with one or more intended receivers of a message scheduled by the SCI-1, the SCI-1 including a first portion of SCI associated with scheduling the message; decoding the SCI-1 based at least in part on a second destination filter indicator associated with the first UE; and receiving the message scheduled by the SCI-1 based at least in part on the first destination filter indicator and the second destination filter indicator.

Aspect 2: The method of aspect 1, wherein the first destination filter indicator and the second destination filter indicator are a same destination filter indicator, the method further comprising: decoding the message scheduled by the SCI-1 based at least in part on the first destination filter indicator and the second destination filter indicator being the same destination filter indicator.

Aspect 3: The method of aspect 2, wherein the SCI-1 includes an indication of the first destination filter indicator, the method further comprising: determining that the first destination filter indicator and the second destination filter indicator are the same destination filter indicator based at least in part on decoding the SCI-1, wherein decoding the message is based at least in part on determining that the first destination filter indicator and the second destination filter indicator are the same destination filter indicator.

Aspect 4: The method of any of aspects 2 or 3, wherein the SCI-1 includes one or more CRC bits that are scrambled by a first ID associated with the first destination filter indicator, the method further comprising: performing an error check for the SCI-1 using a second ID associated with the second destination filter indicator; and passing the error check based at least in part on the first ID and the second ID being a same ID, wherein decoding the message is based at least in part on passing the error check.

Aspect 5: The method of aspect 1, wherein the first destination filter indicator and the second destination filter indicator are different destination filter indicators, the method further comprising: refraining from decoding the message scheduled by the SCI-1 based at least in part on the first destination filter indicator and the second destination filter indicator being different destination filter indicators.

Aspect 6: The method of aspect 5, wherein the SCI-1 includes the first destination filter indicator, the method further comprising: determining that the first destination filter indicator is different from the second destination filter indicator based at least in part on decoding the SCI-1, wherein refraining from decoding the message is based at least in part on determining that the first destination filter indicator is different from the second destination filter indicator.

Aspect 7: The method of any of aspects 5 or 6, wherein the SCI-1 includes one or more CRC bits that are scrambled by a first ID associated with the first destination filter indicator, the method further comprising: performing an error check for the SCI-1 using a second ID associated with the second destination filter indicator; and failing the error check based at least in part on the first ID being different from the second ID, wherein refraining from decoding the message is based at least in part on failing the error check.

Aspect 8: The method of any of aspects 1 through 7, further comprising: receiving SCI-2 associated with the message, the SCI-2 including a subset of a destination ID or a hash function of the destination ID.

Aspect 9: The method of aspect 8, wherein the subset of the destination ID or the hash function of the destination ID uniquely identifies the one or more intended receivers in combination with the first destination filter indicator associated with the SCI-1.

Aspect 10: The method of any of aspects 1 through 9, wherein the SCI-1 includes an indication of the first destination filter indicator, the method further comprising: receiving SCI-2 including a time and frequency resource assignment for the message based at least in part on the SCI-1 including the first destination filter indicator.

Aspect 11: The method of any of aspects 1 through 10, wherein receiving the SCI-1 that is based at least in part on the first destination filter indicator comprises: receiving an indication of the first destination filter indicator via a quantity of bits in the SCI-1.

Aspect 12: The method of aspect 11, wherein the quantity of bits comprise a subset of a destination ID associated with the one or more intended receivers or a hash function of the destination ID associated with the one or more intended receivers.

Aspect 13: The method of any of aspects 11 or 12, wherein the quantity of bits comprise a subset of a source ID associated with the second UE or a hash function of the source ID associated with the second UE.

Aspect 14: The method of any of aspects 11 through 13, wherein the quantity of bits comprise a complete destination ID associated with the one or more intended receivers or a complete source ID associated with the second UE.

Aspect 15: The method of any of aspects 1 through 14, wherein the second UE and the first UE communicate in accordance with a sidelink resource allocation Mode 1.

Aspect 16: A method for wireless communication at a second UE, comprising: receiving scheduling information for a message to be transmitted to at least a first UE; transmitting, over a sidelink control channel, SCI-1 that is based at least in part on a destination filter indicator associated with one or more intended receivers of the message including at least the first UE, the SCI-1 including a first portion of SCI associated with scheduling the message; and transmitting the message according to the received scheduling information, the transmitting of the message based at least in part on the SCI-1.

Aspect 17: The method of aspect 16, further comprising: transmitting SCI-2 associated with the message, the SCI-2 including a subset of a destination ID associated with at least the first UE or a hash function of the destination ID associated with at least the first UE.

Aspect 18: The method of aspect 17, wherein the subset of the destination ID associated with at least the first UE or the hash function of the destination ID associated with at least the first UE uniquely identifies at least the first UE in combination with the destination filter indicator associated with the SCI-1.

Aspect 19: The method of any of aspects 16 through 18, wherein the SCI-1 includes an indication of the destination filter indicator, the method further comprising: transmitting SCI-2 including a time and frequency resource assignment for the message based at least in part on the SCI-1 including the destination filter indicator.

Aspect 20: The method of any of aspects 16 through 19, wherein transmitting the SCI-1 that is based at least in part on the destination filter indicator associated with at least the first UE comprises: transmitting the destination filter indicator via a quantity of bits in the SCI-1.

Aspect 21: The method of aspect 20, wherein the quantity of bits comprise a subset of a destination ID associated with the first UE or a hash function of the destination ID associated with the first UE.

Aspect 22: The method of any of aspects 20 through 21, wherein the quantity of bits comprise a subset of a source ID associated with the second UE or a hash function of the source ID associated with the second UE.

Aspect 23: The method of any of aspects 20 through 22, wherein the quantity of bits comprise a complete destination ID associated with the first UE or a complete source ID associated with the second UE.

Aspect 24: The method of any of aspects 16 through 23, wherein transmitting the SCI-1 that is based at least in part on the destination filter indicator associated with the first UE comprises: transmitting one or more CRC bits that are scrambled by an ID associated with the destination filter indicator.

Aspect 25: The method of aspect 24, wherein the ID is shared by a group of UEs including at least the first UE or is a function of a destination ID associated with at least the first UE.

Aspect 26: The method of any of aspects 16 through 25, wherein receiving the scheduling information for the message to be transmitted to at least the first UE comprises: receiving the scheduling information from a base station, wherein the second UE and at least the first UE communicate in accordance with a sidelink resource allocation Mode 1.

Aspect 27: An apparatus for wireless communication at a first UE, comprising a processor; memory coupled with the processor; and instructions stored in the memory and executable by the processor to cause the apparatus to perform a method of any of aspects 1 through 15.

Aspect 28: An apparatus for wireless communication at a first UE, comprising at least one means for performing a method of any of aspects 1 through 15.

Aspect 29: A non-transitory computer-readable medium storing code for wireless communication at a first UE, the code comprising instructions executable by a processor to perform a method of any of aspects 1 through 15.

Aspect 30: An apparatus for wireless communication at a second UE, comprising a processor; memory coupled with the processor; and instructions stored in the memory and executable by the processor to cause the apparatus to perform a method of any of aspects 16 through 26.

Aspect 31: An apparatus for wireless communication at a second UE, comprising at least one means for performing a method of any of aspects 16 through 26.

Aspect 32: A non-transitory computer-readable medium storing code for wireless communication at a second UE, the code comprising instructions executable by a processor to perform a method of any of aspects 16 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
receive, from a second UE over a sidelink control channel, first-stage sidelink control information that is based at least in part on a first destination filter indicator associated with one or more intended receivers of a message scheduled by the first-stage sidelink control information, the first-stage sidelink control information including a first portion of sidelink control information associated with scheduling the message;
decode the first-stage sidelink control information based at least in part on a second destination filter indicator associated with the first UE; and
receive the message scheduled by the first-stage sidelink control information based at least in part on the first destination filter indicator and the second destination filter indicator.

2. The apparatus of claim 1, wherein the first destination filter indicator and the second destination filter indicator are a same destination filter indicator, and the instructions are further executable by the processor to cause the apparatus to:
decode the message scheduled by the first-stage sidelink control information based at least in part on the first destination filter indicator and the second destination filter indicator being the same destination filter indicator.

3. The apparatus of claim 2, wherein the first-stage sidelink control information includes an indication of the first destination filter indicator, and the instructions are further executable by the processor to cause the apparatus to:
determine that the first destination filter indicator and the second destination filter indicator are the same destination filter indicator based at least in part on decoding the first-stage sidelink control information, wherein decoding the message is based at least in part on determining that the first destination filter indicator and the second destination filter indicator are the same destination filter indicator.

4. The apparatus of claim 2, wherein the first-stage sidelink control information includes one or more cyclic redundancy check bits that are scrambled by a first identifier associated with the first destination filter indicator, and the instructions are further executable by the processor to cause the apparatus to:
perform an error check for the first-stage sidelink control information using a second identifier associated with the second destination filter indicator; and
pass the error check based at least in part on the first identifier and the second identifier being a same identifier, wherein decoding the message is based at least in part on passing the error check.

5. The apparatus of claim 1, wherein the first destination filter indicator and the second destination filter indicator are different destination filter indicators, and the instructions are further executable by the processor to cause the apparatus to:
refrain from decoding the message scheduled by the first-stage sidelink control information based at least in part on the first destination filter indicator and the second destination filter indicator being different destination filter indicators.

6. The apparatus of claim 5, wherein the first-stage sidelink control information includes the first destination filter indicator, and the instructions are further executable by the processor to cause the apparatus to:
determine that the first destination filter indicator is different from the second destination filter indicator based at least in part on decoding the first-stage sidelink control information, wherein refraining from decoding the message is based at least in part on determining that the first destination filter indicator is different from the second destination filter indicator.

7. The apparatus of claim 5, wherein the first-stage sidelink control information includes one or more cyclic redundancy check bits that are scrambled by a first identifier associated with the first destination filter indicator, and the instructions are further executable by the processor to cause the apparatus to:
perform an error check for the first-stage sidelink control information using a second identifier associated with the second destination filter indicator; and
fail the error check based at least in part on the first identifier being different from the second identifier, wherein refraining from decoding the message is based at least in part on failing the error check.

8. The apparatus of claim 1, wherein the instructions are further executable by the processor to cause the apparatus to:
receive second-stage sidelink control information associated with the message, the second-stage sidelink control information including a subset of a destination identifier or a hash function of the destination identifier.

9. The apparatus of claim 8, wherein the subset of the destination identifier or the hash function of the destination identifier uniquely identifies the one or more intended receivers in combination with the first destination filter indicator associated with the first-stage sidelink control information.

10. The apparatus of claim 1, wherein the first-stage sidelink control information includes an indication of the first destination filter indicator, and the instructions are further executable by the processor to cause the apparatus to:
receive second-stage sidelink control information including a time and frequency resource assignment for the message based at least in part on the first-stage sidelink control information including the first destination filter indicator.

11. The apparatus of claim 1, wherein the instructions to receive the first-stage sidelink control information that is based at least in part on the first destination filter indicator are executable by the processor to cause the apparatus to:
receive an indication of the first destination filter indicator via a quantity of bits in the first-stage sidelink control information.

12. The apparatus of claim 11, wherein the quantity of bits comprise a subset of a destination identifier associated with the one or more intended receivers or a hash function of the destination identifier associated with the one or more intended receivers.

13. The apparatus of claim 11, wherein the quantity of bits comprise a subset of a source identifier associated with the second UE or a hash function of the source identifier associated with the second UE.

14. The apparatus of claim 11, wherein the quantity of bits comprise a complete destination identifier associated with the one or more intended receivers or a complete source identifier associated with the second UE.

15. The apparatus of claim 1, wherein the second UE and the first UE communicate in accordance with a sidelink resource allocation Mode 1.

16. An apparatus for wireless communication at a second user equipment (UE), comprising:
a processor;
memory coupled with the processor; and
instructions stored in the memory and executable by the processor to cause the apparatus to:
receive scheduling information for a message to be transmitted to at least a first UE;
transmit, over a sidelink control channel, first-stage sidelink control information that is based at least in part on a destination filter indicator associated with one or more intended receivers of the message including at least the first UE, the first-stage sidelink control information including a first portion of sidelink control information associated with scheduling the message; and
transmit the message according to the received scheduling information, the transmitting of the message based at least in part on the first-stage sidelink control information.

17. The apparatus of claim 16, wherein the instructions are further executable by the processor to cause the apparatus to:
transmit second-stage sidelink control information associated with the message, the second-stage sidelink control information including a subset of a destination identifier associated with at least the first UE or a hash function of the destination identifier associated with at least the first UE.

18. The apparatus of claim 17, wherein the subset of the destination identifier associated with at least the first UE or the hash function of the destination identifier associated with at least the first UE uniquely identifies at least the first UE in combination with the destination filter indicator associated with the first-stage sidelink control information.

19. The apparatus of claim 16, wherein the first-stage sidelink control information includes an indication of the destination filter indicator, and the instructions are further executable by the processor to cause the apparatus to:
transmit second-stage sidelink control information including a time and frequency resource assignment for the message based at least in part on the first-stage sidelink control information including the destination filter indicator.

20. The apparatus of claim 16, wherein the instructions to transmit the first-stage sidelink control information that is based at least in part on the destination filter indicator associated with at least the first UE are executable by the processor to cause the apparatus to:
transmit the destination filter indicator via a quantity of bits in the first-stage sidelink control information.

21. The apparatus of claim 20, wherein the quantity of bits comprise a subset of a destination identifier associated with the first UE or a hash function of the destination identifier associated with the first UE.

22. The apparatus of claim 20, wherein the quantity of bits comprise a subset of a source identifier associated with the second UE or a hash function of the source identifier associated with the second UE.

23. The apparatus of claim 20, wherein the quantity of bits comprise a complete destination identifier associated with the first UE or a complete source identifier associated with the second UE.

24. The apparatus of claim 16, wherein the instructions to transmit the first-stage sidelink control information that is based at least in part on the destination filter indicator associated with the first UE are executable by the processor to cause the apparatus to:
transmit one or more cyclic redundancy check bits that are scrambled by an identifier associated with the destination filter indicator.

25. The apparatus of claim 24, wherein the identifier is shared by a group of UEs including at least the first UE or is a function of a destination identifier associated with at least the first UE.

26. The apparatus of claim 16, wherein the instructions to receive the scheduling information for the message to be transmitted to at least the first UE are executable by the processor to cause the apparatus to:
receive the scheduling information from a base station, wherein the second UE and at least the first UE communicate in accordance with a sidelink resource allocation Mode 1.

27. A method for wireless communication at a first user equipment (UE), comprising:
receiving, from a second UE over a sidelink control channel, first-stage sidelink control information that is based at least in part on a first destination filter indicator associated with one or more intended receivers of a message scheduled by the first-stage sidelink control information, the first-stage sidelink control information including a first portion of sidelink control information associated with scheduling the message;
decoding the first-stage sidelink control information based at least in part on a second destination filter indicator associated with the first UE; and
receiving the message scheduled by the first-stage sidelink control information based at least in part on the first destination filter indicator and the second destination filter indicator.

28. The method of claim 27, wherein the first destination filter indicator and the second destination filter indicator are a same destination filter indicator, the method further comprising:
decoding the message scheduled by the first-stage sidelink control information based at least in part on the first destination filter indicator and the second destination filter indicator being the same destination filter indicator.

29. A method for wireless communication at a second user equipment (UE), comprising:
receiving scheduling information for a message to be transmitted to at least a first UE;
transmitting, over a sidelink control channel, first-stage sidelink control information that is based at least in part on a destination filter indicator associated with one or more intended receivers of the message including at least the first UE, the first-stage sidelink control information including a first portion of sidelink control information associated with scheduling the message; and
transmitting the message according to the received scheduling information, the transmitting of the message based at least in part on the first-stage sidelink control information.

30. The method of claim 29, further comprising:
transmitting second-stage sidelink control information associated with the message, the second-stage sidelink control information including a subset of a destination identifier associated with at least the first UE or a hash function of the destination identifier associated with at least the first UE.
